(19) United States
(12) Patent Application Publication
(10) Pub. No.: US 2010/0172026 A1
(43) Pub. Date: Jul. 8, 2010

(54) EYE CUP

(75) Inventors: Carl Steiner, Bindlach (DE); Manfred Fischbach, Himmelkron-Gossenreuth (DE)

Correspondence Address: BROWDY AND NEIMARK, P.L.L.C.;624 NINTH STREET, NW, SUITE 300, WASHINGTON, DC, 20001-5303, US

(73) Assignee: STEINER-OPTIK GmbH, Bayreuth (DE)

(21) Appl. No.: 12/666,087

(22) PCT Filed: Jun. 17, 2008
(86) PCT No.: PCT/EP08/04864

§ 371 Date: Dec. 22, 2009

(30) Foreign Application Priority Data
Jun. 20, 2007 (DE) 10 2007 028 408.1

(51) Int. Cl. G02B 23/18

(52) U.S. Cl. 359/600

(57) ABSTRACT

In an eye cup for an eyepiece of an optical observation apparatus, for individual and convenient adjustment of the eye cup it is provided that a second adjusting element can be rotated in a mode dependent on a compressive force independently or together with a first adjusting element, such that a light-shield section can be positioned as desired for any distance of the adjusting elements with respect to one another.

The invention relates to an eye cup for an eyepiece of an optical observation apparatus, especially for a pair of binoculars.

In optical observation apparatuses, eye cups create a connection between the eyepiece and the eye of the user. Known eye cups have a light-shield section that laterally covers the gap between the eyepiece and the user's face in order to protect against distracting lateral incident light. An eye cup of this type is known, for example, from DE 20 2004 001 705 U1.

Furthermore, known eye cups have an adjusting mechanism that allows the distance between the exit pupil of the eyepiece and the eye of the user to be adjusted. Adjusting this distance is performed in such a way that parts of the eye cup are arranged so as to be rotatable with respect to one another, such that when one part is rotated the distance to the other part is changed. A shortcoming lies in that care must always be taken during the adjusting process that the light-shield section is positioned laterally, which significantly limits the adjustment possibilities and ease of use.

Proceeding from this, the invention is based on the aim of improving an eye cup for an eyepiece of an optical observation apparatus in such a way that the distance between the eyepiece and an eye of a user can be adjusted individually and conveniently.

This aim is achieved according to the invention by an eye cup that has
a. a connecting element for connecting the eye cup to the eyepiece,
b. a first adjusting element for adjusting a distance along a longitudinal axis between the connecting element and the first adjusting element during a rotation of the first adjusting element relative to the connecting element, and
c. a second adjusting element,
   i. having a pressure section and a light-shield section,
   ii. being designed such that, at a compressive force on the pressure section below a compressive force threshold the second adjusting element can be rotated independently from the first adjusting element, and,
   iii. being designed such that, at a compressive force on the pressure section above a compressive force threshold the second adjusting element can be rotated together with the first adjusting element.

Because, at a compressive force above a compressive force threshold the second adjusting element can be rotated together with the first adjusting element, the distance between the connecting element and the first adjusting element can be set in a simple manner and the distance between the eyepiece and the eye of the user can thus be adjusted. Once the distance has been adjusted as desired, the second adjusting element with the light-shield section can be rotated at a reduced compressive force below a compressive force threshold independently from the first adjusting element, and the light-shield section can be positioned laterally. The inventive eye cup can thus be adjusted to a desired distance between the eyepiece and an eye of the observer, and the light-shield section can be positioned laterally for any desired distance. The adjusting options and ease of use are thereby markedly increased.

The pressure section advantageously has at least one raised area provided on an inner wall. Such a raised area improves the transmission of compressive forces from the pressure section to the second adjusting element.

Advantageously, a plurality of raised areas are provided that are arranged equidistantly along the inner wall. Such a placement of a plurality of raised areas allows the compressive force to be exerted at any random point of the pressure section.

Furthermore, it is advantageously provided that the at least one raised area is designed as one piece with the pressure section. Such a design allows the eye cup to be produced cost effectively.

Advantageously, the at least one raised area is made of silicone. Silicone, because of its elasticity, permits an even transmission of compressive forces onto the second adjusting element and the silicone at the same time also allows for an adequate frictional contact.

Advantageously, a fastening element for fastening the second adjusting element along the longitudinal axis is provided on the first adjusting element. Such a fastening element permits a simple and reliable fastening of the second adjusting element to the first adjusting element, with the second adjusting element remaining rotatable relative to the first adjusting element. The fastening element and the second adjusting element are connected to one another in a positive locking manner. The second adjusting element can therefore be rotated only together with the fastening element relative to the first adjusting element.

Advantageously, the fastening element has at least one opening through which the at least one raised area extends by at least a portion thereof. Such a design of the fastening element permits a simple transmission of compressive forces by means of the at least one raised area in combination with the fastening element.

Additionally, it is advantageously provided that the fastening element has, for fastening same to the first adjusting element at least one detent locking section. Such a detent locking section allows for a simple fastening.

Advantageously, the first adjusting element can be interlocked with the connecting element. Such a design permits a locking of the first adjusting element relative to the connecting element.

Advantageously, the fastening element has an annular section incorporating an integral annular collar, wherein the annular collar extends, starting from a fastening element inner wall toward the first adjusting element and rests against a projection of the first adjusting element. Such an annular collar secures the fastening element to the first adjusting element and, at the same time, permits a simple rotation of the fastening element relative to the first adjusting element.

Advantageously, a plurality of openings are arranged centrally and equidistantly in the annular section. Such an arrangement of a plurality of openings permits a transmission of force from the second adjusting element to the first adjusting element evenly about the circumference.

Furthermore, it is advantageously provided that in the annular section a plurality of detent locking sections are formed opposite the annular collar. Such an arrangement of detent locking sections secures the fastening element to the first adjusting element and, at the same time, permits a simple rotation of the fastening element relative to the first adjusting element.

The detent locking sections advantageously rest with one detent locking hook in each case against a projection of the first adjusting element. Such a design permits a rotation of the fastening element relative to the first adjusting element with little expenditure of force, since the frictional resistance is low.

Advantageously, the fastening element is designed in the form of a sliding ring. Such a design permits a low frictional resistance between the first adjusting element and the fastening element. In particular, the sliding ring is made of a material that has a low frictional resistance when gliding on the material of the first adjusting element. Advantageously, the sliding ring is made of a plastic that can glide on the material of the first adjusting element.

Furthermore, it is advantageously provided that the fastening element is made of a harder material than the second adjusting element. With such a design the transmission of force from the second adjusting element to the first adjusting element can take place reliably and finely proportioned. Advantageously, the fastening element is made of plastic, while the second adjusting element is made of an elastic material, such as rubber or silicone. It is particularly advantageous if the fastening element is designed in the form of a sliding ring.

The invention will be described in more detail below based on a preferred illustrative embodiment in conjunction with the drawing, in which:

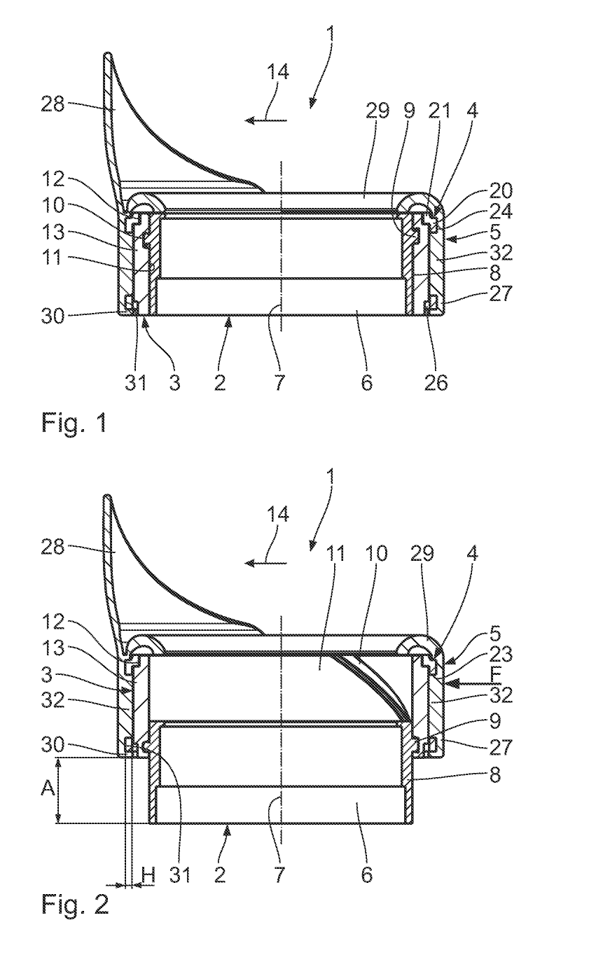

FIG. 1 shows an axial section through an eye cup in a first adjusted position,

FIG. 2 shows an axial section through the eye cup according to FIG. 1 in a second adjusted position,

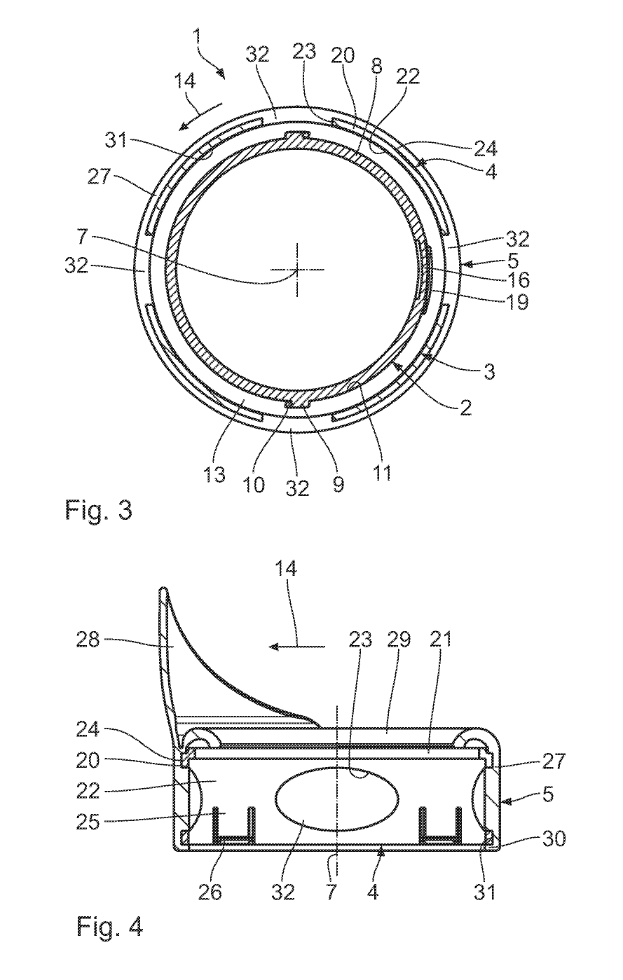

FIG. 3 shows a cross-sectional view through the eye cup according to FIG. 1,

FIG. 4 shows an axial section through a second adjusting element and fastening element of the eye cup according to FIG. 1, and

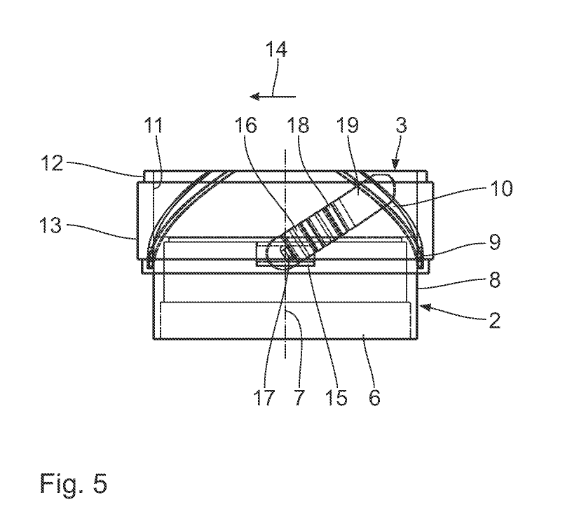

FIG. 5 shows a side view of a connecting element and first adjusting element of the eye cup according to FIG. 1.

An eye cup 1 for an eyepiece of an optical observation apparatus has a connecting element 2, a first adjusting element 3, a fastening element 4 and a second adjusting element 5. The optical observation apparatus may be, for example, a pair of binoculars, a microscope, or a telescope.

The connecting element 2 is designed in the form of a sleeve and has, for connecting the eye cup 1 to the not depicted eyepiece, a connecting section 6 that can be fixedly connected to the eyepiece.

The connecting element 2 has a longitudinal axis 7 that coincides with an optical axis of the eyepiece. Two guide pins 9 that are situated opposite each other are disposed on a connecting element outer wall 8.

The guide pins 9 are arranged in guide slots 10 that are formed in the first adjusting element 3 and that are open toward a first adjusting element inner wall 11. The guide slots 10 extend in the form of a partial helical path. On a first adjusting element outer wall 12, the first adjusting element 3 has a projection 13 extending centrally about the periphery thereof. The first adjusting element 3 is designed corresponding to the connecting element 2 in the form of a sleeve and encompasses same.

Because the guide pins 9 are arranged in the guide slots 10, the first adjusting element 3 can be rotated relative to the connecting element 2, and during a rotation of the first adjusting element 3 in a direction of rotation 14 the first adjusting element 3 creates a distance A relative to the connecting element 2 along the longitudinal axis 7. The distance A is adjustable in a mode depending on the rotation. In order to lock the first adjusting element 3 relative to the connecting element 2, same has a detent locking opening 15 in which a detent locking tab 16 with an obliquely disposed detent locking projection 17 is arranged. The detent locking projection 17 cooperates with a plurality of parallel and spaced-apart detent locking grooves 18 that are arranged in a detent locking region 19 on the first adjusting element inner wall 11.

The fastening element 4 is arranged between the first adjusting element 3 and the second adjusting element 5 and fastens the second adjusting element 5 relative to the first adjusting element 3 along the longitudinal axis 7. The fastening element 4 has an annular section 20 on which an annular collar 21 is integrally formed. The annular collar 21 extends, starting from a fastening element inner wall 22 toward the first adjusting element 3, with the annular collar 21 resting against the projection 13 and the first adjusting element outer wall 12. In the annular section 20, four oval openings 23 are arranged centrally and equidistantly from each other, with the openings 23 extending starting from the fastening element inner wall 22 to a fastening element outer wall 24. Opposite the annular collar 21, a plurality of detent locking sections 25 are formed in the annular section 20, each resting with a detent locking hook 26 against the projection 13 and the first adjusting element outer wall 12.

The second adjusting element 5 is connected in a positive locking manner to the fastening element 4 and substantially fully encompasses same. The second adjusting element 5 has a ring shaped pressure section 27 on which a light-shield section 28 and a bearing section 29 is integrally formed. The light-shield section 28 substantially extends about a periphery of 180° and tapers to a point starting from the pressure section 27 toward the longitudinal axis 7. The bearing section 29 is designed substantially ring shaped and has a cross section in the shape of a semi-circle. The bearing section 29 is disposed in the region of the light-shield section 28 on the inside thereof. Opposite the bearing section 29, an annular collar section 30 is integrally formed on the pressure section 27, extending radially toward the first adjusting element 3 and encompassing the annular section 20 of the fastening element 4. A number of raised areas 32 corresponding to the number of openings 23 is formed on an inner wall 31 of the pressure section 27, radially extending from the inner wall 31 toward the first adjusting element 3. The raised areas 32 are formed integrally with the pressure section 27 and correspond in their shape and arrangement to the shape and arrangement of the openings 23. The raised areas 32 extend through the openings 23 and have a height H in the radial direction, such that a radial compressive force F onto the pressure section 27 below a compressive force threshold F_{D} allows the second adjusting element 5 to be rotated independently from the first adjusting element 3, and that a compressive force F onto the pressure section 27 above a compressive force threshold F_{D} allows the second adjusting element to be rotated only together with the first adjusting element 3.

The fastening element 4 is designed in the form of a sliding ring and is made of a material that can glide on the material of the first adjusting element 3. Furthermore, the material of the fastening element 4 has a greater hardness as compared to the material of the second adjusting element 5. Advantageously, the first adjusting element 3 and the fastening element 4 are made of plastic and the second adjusting element 5 is made of an elastic material, such as rubber or silicone, for example.

The pressure section 27, the light-shield section 28, the bearing section 29, the annular collar section 30 and the raised areas 32 are advantageously produced as one piece from silicone.

In the text that follows, the function of the inventive eye cup 1 will be described with reference to FIGS. 1 to 5. FIG. 1 shows the eye cup 1 in a first adjusted position, in which the distance A between the first adjusting element 3 and the second adjusting element 5 is zero. In order to adjust the distance A, a user must first exert a radial compressive force F above a compressive force threshold F_{D} onto the pressure section 27, such that the raised areas 32 are pressed against the projection 13. During a subsequent rotation of the second adjusting element 5 about the longitudinal axis 7 in the direction of rotation 14, the first adjusting element 3 is carried along due to the frictional engagement between the raised areas 32 and the projection 13. The first adjusting element 3 is therefore rotated together with the second adjusting element 5 without slippage in the direction of rotation 14. With this rotation, the first adjusting element 3 is rotated relative to the connecting element 2, such that the guide pins 9 move along the guide slots 10 and the distance A becomes larger. In principle the distance A can be adjusted to any desired distance. It is advantageous, however, if adjusting the distance A is done in such a way that the detent locking nose 17 comes to rest in one of the detent locking grooves 18, as this achieves a greater resistance against unintentional rotation and thereby achieves a locking FIG. 2 shows the eye cup 1 in a second adjusted position, in which the distance A is at its maximum. The described rotation of the first and second adjusting element 3, 5 thus makes it possible to adjust the distance between the eyepiece and the eye of the user as desired.

In order to position the light-shield section 28 laterally for any distance A, the user needs to reduce the radial compressive force F on the pressure section 27 to below the compressive force threshold F_{D}. At such a reduced compressive force F the raised areas 32 substantially do not rest against the projection 13, such that the second adjusting element 5 is rotatable together with the fastening element 4 independently from the first adjusting element 3 about the longitudinal axis 7. The frictional resistance between the fastening element 4 and second adjusting element 5 with respect to the first adjusting element 3 is significantly smaller than the frictional resistance between the first adjusting element 3 and the connecting element 2, such that the second adjusting element 5 can be rotated independently from the first adjusting element 3. The light-shield section 28 can thus be rotated to any desired position without causing the distance A to be changed. If a compressive force F is then no longer exerted on the pressure section 27, the frictional resistance of the fastening element 4 and second adjusting element 5 relative to the first adjusting element 3 is nonetheless sufficiently great to prevent a self-acting rotation of the second adjusting element 5.

The inventive eye cup 1, due to the manifold adjustment possibilities, can therefore be individually adapted to the needs of the user, in particular also of spectacle-wearers. Because the first adjusting element 3 is carried along or not in a mode depending on a compressive force on the second adjusting element 5, adjusting the eye cup 1 is easy and very convenient for the user.

1. An eye cup for an eyepiece of an optical observation device, having
a. a connecting element (2) for connecting the eye cup (1) to the eyepiece,
b. a first adjusting element (3) for adjusting a distance (A) along a longitudinal axis (7) between the connecting element (2) and the first adjusting element (3) during a rotation of the first adjusting element (3) relative to the connecting element (2), and
c. a second adjusting element (5),
i. having a pressure section (27) and a light-shield section (28),
ii. being designed such that, at a compressive force (F) on the pressure section (27) below a compressive force threshold (F_{D}) the second adjusting element (5) can be rotated independently from the first adjusting element (3), and
iii. being designed such that, at a compressive force (F) on the pressure section (27) above a compressive force threshold (F_{D}) the second adjusting element (5) can be rotated together with the first adjusting element (3).

2. An eye cup according to claim 1, wherein the pressure section (27) has on an inner wall (31) at least one raised area (32).

3. An eye cup according to claim 2, wherein a plurality of raised areas (32) are provided that are arranged equidistantly along the inner wall (31).

4. An eye cup according to claim 2, wherein the at least one raised area (32) is designed as one piece with the pressure section (27).

5. An eye cup according to claim 1, wherein the at least one raised area (32) is made of silicone.

6. An eye cup according to claim 1, wherein a fastening element (4) is provided for fastening the second adjusting element (5) along the longitudinal axis (7) to the first adjusting element (3).

7. An eye cup according to claim 6, wherein the fastening element (4) has at least one opening (23) through which the at least one raised area (32) extends by at least a portion thereof.

8. An eye cup according to claim 6, wherein the fastening element (4), for connecting same to the first adjusting element (3) has at least one detent locking section (25).

9. An eye cup according to claim 1, wherein the first adjusting element (3) can be interlocked with the connecting element (2).

10. An eye cup according to claim 6, wherein the fastening element (4) has an annular section (20) having an integral annular collar (21), said annular collar (21) extending, starting from a fastening element inner wall (22) toward the first adjusting element (3) and resting against a projection (13) of the first adjusting element (3).

11. An eye cup according to claim 10, wherein a plurality of openings (23) are arranged centrally and spaced equidistantly from each other in the annular section (20).

12. An eye cup according to claim 10, wherein a plurality of detent locking sections (25) are formed opposite the annular collar (21) in the annular section (20).

13. An eye cup according to claim 12, wherein the detent locking sections (25) rest with a detent locking hook (26) in each case against the projection (13) of the first adjusting element (3).

14. An eye cup according to claim 6, wherein the fastening element (4) is designed in the form of a sliding ring.

15. An eye cup according to claim 6, wherein the fastening element (4) is made of a harder material than the second adjusting element (5).
